(19) United States
(12) Patent Application Publication
(10) Pub. No.: US 2004/0182329 A1
(43) Pub. Date: Sep. 23, 2004

(54) Pet transportation device

(76) Inventor: Kevin Kroculick, Harrisburgh, PA (US)

Correspondence Address: Kevin Kroculick, 115 Ringneck Drive, Harrisburg, PA, 17112, US

(21) Appl. No.: 10/390,298

(22) Filed: Mar. 17, 2003

(51) Int. Cl. A01K 15/04

(52) U.S. Cl. 119/753

(57) ABSTRACT

A pet transportation device that provides additional space for the pet, in particular the medium and large size dog, while being transported in a typical motor vehicle. A thin, lightweight, rigid, device rests on the vehicle's seat. A portion of the device is snugly inserted between the seat and the backrest. A portion of the device extends over the foot rest area, which is otherwise not utilized during pet transport. The additional space allows the pet to be more comfortable and relaxed during pet transport. The device also helps protect the vehicle's seat from damage. A typical dog nest, blanket, or pet carrier can overlay the device to provide additional comfort for the pet.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

(1) Field of the Invention

The present invention is a device used to aid in the transportation of a pet, in particular medium and large size dogs, while in a motor vehicle.

(2) Description of Related Art including information disclosed under 37 CFR 1.97 and 1.98.

Edwards, U.S. Pat. No. 5,479,892 discloses a vehicle safety seat for pets. The safety seat includes a base that sits on a vehicle seat but does not overhang the seat to provide additional area so a medium or large size pet can lay down and relax.

Fricano, U.S. Pat. No. 5,685,568 discloses a canine car seat having a cylindrical housing that sits on the car seat and does not overhang the seat. A seat belt is tightened around the housing for transport.

Reese, U.S. Design Pat. Des. No. 461,966 and Stump, U.S. Design Pat. Des. No. 376,447 each disclose an animal automobile seat having a base that sits on a vehicle seat and a raised platform atop the base.

Dean, U.S. Pat. No. 5,487,361 discloses a supplemental auto seat for use by an animal. The seat includes a horizontal seat component and a vertical seat component. The horizontal seat component overhangs the vehicle seat. The overhang is supported by a pair of vertical legs that extend to the vehicle floor.

Wallace et al., U.S. Pat. No. 4,969,683 discloses a vehicle seat protector for transporting animals. The animal sits on the seat and on the seat protector.

### BRIEF SUMMARY OF THE INVENTION

Many people have pets, especially medium and large size dogs. On occasion, pet owners must transport their pets in their vehicles. These trips may include visits to the veterinary doctor, travel, taking them to a walking trail, and the like.

Transporting a pet in a vehicle can be an unpleasant experience for the pet, and the pet's owner.

In many instances, the pet cannot get comfortable because the average seat in the typical car, truck, sport utility vehicle, or van is slightly smaller than the required space the pet needs to lie down. Additionally, the vehicle's seat can become dirty, full of hair, torn, or otherwise damaged during the pet transportation process.

The Edwards, Fricano, Reese and Stump references each disclose an animal seat that rests on the vehicle seat and does not overhang the seat to provide additional area. This limits the usefulness of the animal seat to small or, at best, medium-sized animals. These inventions are also relatively difficult and expensive to manufacture and distribute.

The Dean reference discloses an overhanging horizontal seat component supported by legs that extend to the vehicle floor. The legs take up valuable floor space that could be used for transporting animal supplies or other items. The removable legs may further complicate the manufacture of the device and may hinder quick installation and removal. Additionally, the seat height of seats contained in automobiles, trucks, and vans vary, making it preferable to eliminate the need for leg supports. The present invention is further distinguished from Dean in that it is uniquely shaped to provide maximum area, yet conform to the concave shape of most seats. Finally, the present invention is further distinguished in that no vertical back is provided. The vertical back portion and associated hinge further complicates manufacture, and the vertical back portion must be attached to the seat, otherwise it may fall forward.

In view of the foregoing discussion, the objective of the present invention is to provide a simple to use, inexpensive to manufacture, easily removable device that effectively extends the seat area of the typical vehicle and is capable of transporting larger animals, such as large dogs. Providing a device that extends the seat considerably increases the overall area that the pet has while in the vehicle. Achieving this objective makes the pet more comfortable during transportation.

It is another objective of the present invention that the device not take up valuable floor space in the vehicle while in use.

It is yet another objective of the present invention to provide some protection to the vehicle's seat from dirt, scratches, tears, and other perils.

It is a further objective of the present invention to make pet transportation less difficult and stressful on pet owners. Providing more space for the pet, which makes the pet more comfortable so they can relax or sleep, while substantially protecting the seat from damage, helps achieve this goal.

### BRIEF DESCRIPTION OF THE SEVERAL VIEWS OF THE DRAWINGS

FIG. 1A is a top perspective view of a first embodiment device of the present invention.

FIG. 1B is a side perspective view of the device shown in FIG. 1B.

FIG. 2 shows the device shown in FIG. 1A installed in the front passenger seat of a typical motor vehicle.

FIG. 3 shows a typical dog nest and pet overlying the device shown in FIG. 2.

### DETAILED DESCRIPTION OF THE INVENTION

Typical motor vehicle 10 includes seat 12, dashboard 13, and floor space 14. Seat 12 includes seatrest 16, backrest 18, seat adjuster 19, and seat interface 20. A fabric flap 17 attaches seatrest 16 and backrest 18. Floor space 14 is located above the vehicle floor 21 in front of seat 12.

A preferred embodiment that has been selected to illustrate the removable pet-transportation device 22 comprises an elongated platform formed from thin, rigid, lightweight, resilient, planar material. For illustrative purposes, the terms pet transportation device and platform are synonymous, and extension portion and cantilever beam are also synonymous.

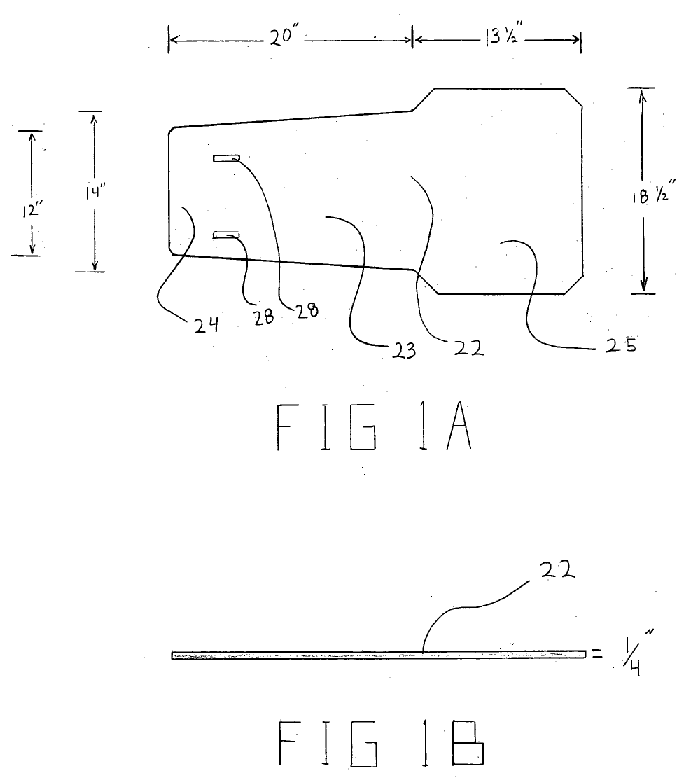

The platform 22 includes axially aligned contiguous body portion 23, securing portion 24, and extension portion 25, as shown in FIG. 1A. The platform 22 is preferably made from wood, rigid plastic, or fiberglass. Other materials can be used, and the platform 22 can be formed from combinations of materials. An outer decorative covering for coordinating with the vehicle interior or a resilient outer layer can be provided if desired.

Pet transportation device 22 is shaped complementary to the seatrest 16. Pet transportation device 22 is smooth and has rounded edges as to not damage seat 12. The extension portion 25 is preferably wider than the supporting portion 23 as shown to the extent permitted by the vehicle's interior. The preferred dimensions of the illustrated pet transportation device are shown on FIG. 1A and FIG. 1B; preferably the platform has a constant thickness for ease of manufacture and to provide a uniformly flat surfaces on both sides of the platform.

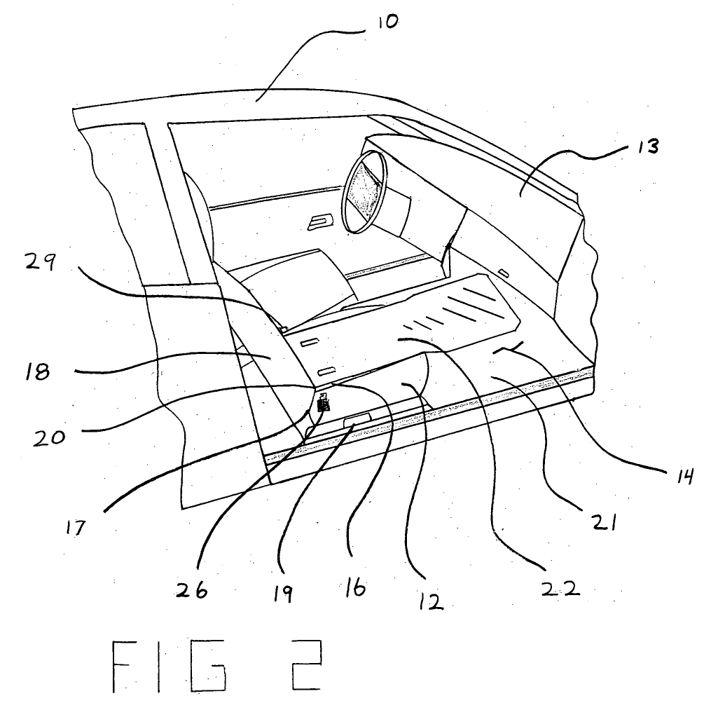

To install the pet transportation device 22, seat 12 is adjusted rearward with seat adjuster 19 to provide maximum floor space. Pet transportation device 22 is disposed over seatrest 16 and securing portion 23 of pet transportation device 22 is snuggly inserted into seat interface 20, as shown in FIG. 2. The seatrest 16 supports the securing portion 23 and the extension portion 25 overhangs the seatrest 16 above the vehicle floor. Pet transportation device 22 is shown being installed in a vehicle front seat but, in similar fashion, pet transportation device 22 can be installed in the rear seat instead.

When installed, the extension portion 25 forms a cantilever beam that overhangs the vehicle seatrest without the need for legs supporting the overhanging portion. This enables the entire floor beneath the cantilever beam to be used for storage and maximizes the pet area.

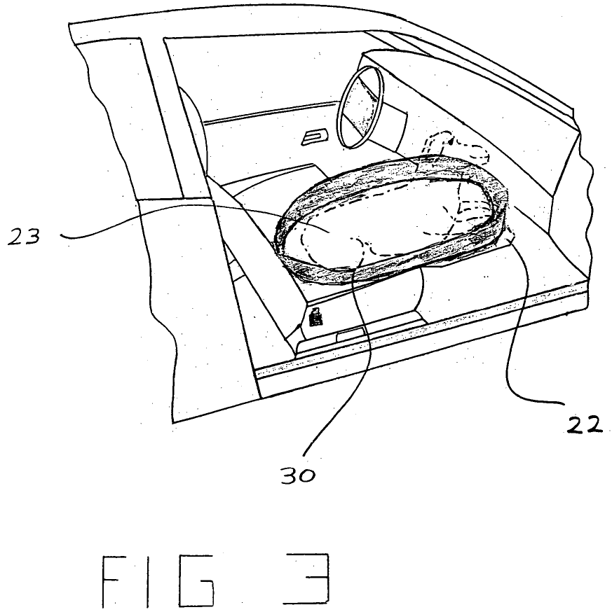

In use, a pet carrier, such as a 28-inch dog bed or dog nest 30, available in many pet stores and from pet supply catalogs, is placed in overlying relationship to pet transportation device 22, as shown in FIG. 3. Other pet carriers, including cages or boxes, could be used. The dog nest 30 is supported against the backrest 18 and extends onto the extension portion 25 extending from the seat. The pet 23 can sit, lie, or otherwise snuggle comfortably in nest 30. Another arrangement would be to substitute a blanket for nest 30.

Pet transportation device 22 is capable of supporting a dog nest or other pet carrier larger than the seatrest 16 by providing the extension portion 25 to support the portion of the carrier that would otherwise extend beyond the seat. This enables transporting a large pet or pet carrier that could not fit in the seat, and does so without using up valuable floor space. The entire floor space below the cantilever beam is available for carrying pet supplies or other items.

Depending on the position of the dog, the weight of the dog and dog nest urges the pet transportation device 22 to rotate clockwise as viewed in FIG. 3 and urges the securing portion 24 to lift up and off the seatrest 16. The backrest 18 engages the securing portion 24 and resists rotation of the portion 24, thereby maintaining pet transportation device 22 in place. Friction between pet transportation device 22 and the seat interface 20 resists lateral movement of the pet transportation device 22 during vehicle deceleration.

In most instances, pet transportation device 22 can be snuggly inserted into seat interface 20. However, if fabric flap 17 prevents securing portion 24 from being fully inserted into interface 20, or anytime a snug fit cannot be achieved, the pet owner can further secure pet transportation device 22 to seatrest 16 by inserting seat belt 26 through slots 28 and locking into seatbelt lock 29. This arrangement would be similar in fashion to securing a child's safety seat; therefore details of this common configuration are not shown.

Possible pet seats that can be used with the present invention include the seats disclosed in the Dean, Edwards, Fricano, Reese and Stump references identified above and modified to extend over the seat for transporting larger dogs or pets.

Thus, it is readily understood how the preferred and generic-variant embodiments of this invention contemplates performing functions in a novel way not heretofore available nor realized. It is implicit that the utility of the forgoing adaptations of this invention are not necessarily dependant upon any prevailing invention patent; and while the present invention has been well described herein by way of certain illustrated embodiments, it is to be expected that various changes, alteration, rearrangements, and modifications may be resorted to by those skilled in the art without substantially departing from the implied spirit and scope of the present invention.

Therefore, the invention has been disclosed herein by way of example, and not as imposed limitation, while the appended claims set out the scope of the invention sought, and are to be construed broadly as the terminology therein employed permits, reckoning that the invention verily comprehends every use of which it is susceptible.

What I claim as my invention is:

1. A pet transportation device for use in motor vehicles having an existing motor vehicle seat of the type which has a seatrest, comprising:
a uniquely shaped, thin, rigid, lightweight, portable platform, consisting of a contiguous;
body portion;
securing portion;
and extension portion;
wherein the body portion substantially rests on the vehicle's front or rear seat, the securing portion is snugly inserted between the seatrest and backrest, and the extension portion substantially extends over the floor area forming a stable platform;
wherein the body portion is uniquely sized and shaped so that a portion of the device rests on the vehicle's passenger front seat or rear seat; the securing portion sized and shaped so it can be snugly inserted between the seat's backrest and seat rest; and the extension portion is sized and shaped to provide additional area for the pet while being transported in the vehicle; and
wherein the device is uniquely shaped to removably cover a substantial portion of the seat and floor area of a motor vehicle, providing substantial protection for the seat portion and providing additional area for a pet while being transported in the cabin compartment of a motor vehicle, making pet transportation more enjoyable for the pet and the pet owner.

2. The transport device of claim 1 that is easily and quickly installed and removed from the vehicle.

3. The transport device of claim 1 that includes two slots whereby the vehicle's seat belt can be inserted through to further secure device to seat.

4. A device for transporting a pet or other item by motor vehicle having an existing motor vehicle seat of the type which has a seatrest, the device comprising:
a platform comprising opposed ends and upper and lower surfaces;
a securing portion at one end and an extension portion at the other end;
the lower surface of the securing portion being configured to substantially cover and be supported on the seatrest of the existing vehicle seat when the platform is installed in the motor vehicle;
the extension portion extending away from the seatrest and forming a cantilever beam when the platform is installed in the motor vehicle; and
means for temporarily and nonrotatably mounting the securing end of the platform to the seatrest when the platform is installed in the motor vehicle, wherein rotation of the platform is resisted by said means when a load is carried on the upper surface of said cantilever beam,
whereby the platform can be temporarily installed on the seatrest of the motor vehicle for carrying a load, the load wholly or partially carried on the cantilever beam portion of the platform while being transported by the motor vehicle without losing vehicle floor space beneath the cantilever beam, and the platform can then be removed from the motor vehicle for normal use of the seat.

5. The transport device of claim 4 wherein the vehicle seat includes a backrest and the means for nonrotatably mounting the platform comprises the securing portion of the platform being disposed between the seatrest and the seatback.

6. The transport device of claim 4 wherein the vehicle seat comprises a seat belt, and the means for nonrotatably mounting the platform comprises means for attaching the platform to the seat with said seatbelt wherein the seat belt resists rotation of the securing end of the platform away from the seatrest.

7. A method of transporting a pet in a motor vehicle having a seat, the method comprising the steps of:
(a) placing a platform on the seatrest of the vehicle seat;
(b) positioning the platform on the seatrest wherein a portion of the platform forms a cantilever beam extending away from the seatrest;
(c) forming a nonrotatable connection between the platform and the seatrest to resist rotation of the platform away from the seatrest; and
(d) placing the pet at least partially on the cantilever beam; and
(e) transporting the pet by motor vehicle after performing step (d).

8. The method of claim 7 wherein step (c) comprises the step of:
(f) inserting the platform between the seatrest and seatback of the seat.

9. The method of claim 7 wherein the seat comprises a seat belt and step (c) comprises the step of:
(g) buckling the platform to the seat with the seatbelt.

10. The method of claim 7 wherein step (d) comprises the step of:
(h) placing a nest, blanket or pet carrier at least partially on the cantilever beam portion of the platform; and
(i) placing the pet on or in such nest, blanket or pet carrier.
